(19) United States
(12) Patent Application Publication
(10) Pub. No.: US 2023/0325920 A1
(43) Pub. Date: Oct. 12, 2023

(54) CARBON REDUCTION COMPENSATION METHOD AND DEVICE BASED ON OBD

(71) Applicant: HL KLEMOVE CORP., Incheon (KR)

(72) Inventor: Seongjoo MOON, Gyeonggi-do (KR)

(21) Appl. No.: 18/123,227

(22) Filed: Mar. 17, 2023

(30) Foreign Application Priority Data
Mar. 18, 2022 (KR) 10-2022-0033785

(51) Int. Cl. G06Q 40/04; G06Q 30/018; G07C 5/08; G06N 3/0442

(52) U.S. Cl. CPC G06Q 40/04; G06N 3/0442; G06Q 30/018; G07C 5/0808

(57) ABSTRACT

The present disclosure relates to an on board diagnostics (OBD)-based carbon reduction compensation method. The OBD-based carbon reduction compensation method includes acquiring sensor data of a vehicle through OBD associated with the vehicle, calculating carbon emissions according to driving of the vehicle by using the acquired sensor data, determining carbon reductions according to driving of the vehicle based on the calculated carbon emissions, performing trading of certified emissions reductions (CERs) according to the determined carbon reductions through a carbon trading market, and providing a portion of an amount obtained through the trading to a first user account associated with the vehicle.

### CROSS-REFERENCE TO RELATED APPLICATION

This application claims priority under 35 U.S.C. §119 to Korean Patent Application No. 10-2022-0033785, filed on Mar. 18, 2022, in the Korean Intellectual Property Office (KIPO), the disclosure of which is incorporated by reference herein in its entirety.

### BACKGROUND

### 1. Field of the Invention

One or more example embodiments relate to an on board diagnostics (OBD)-based carbon reduction compensation method and device, and more particularly, to an OBD-based carbon reduction compensation method and device that determines carbon reductions of a vehicle using an OBD scanner and performs trading of certified emission reductions (CERs) according to carbon reductions.

### 2. Description of the Related Art

CERs are the right to emit carbon gas, which may be formed when a corporation or an individual emits less carbon gas than the assigned annual carbon emissions. CERs may be traded and sold to other corporations or countries. For example, drivers and vehicle manufacturers of electric vehicles and hydrogen vehicles may earn profits by selling CERs according to carbon emissions reduced by driving the vehicle. However, in general, there is a problem in that it is difficult for an individual to directly calculate carbon emissions reduced by driving the vehicle and sell CERs corresponding to the calculated carbon emissions through a carbon trading market.

### SUMMARY

Example embodiments provide an OBD-based carbon reduction compensation method for solving the above problems, a computer program stored in a non-transitory computer readable medium storing instructions, and a computer readable medium and a device (system) on which the computer program is stored.

Example embodiments may be implemented in a variety of ways, including a method, a device (system), a computer program stored on a computer-readable medium, or a non-transitory computer readable medium on which the computer program is stored.

According to an example embodiment, an OBD-based carbon reduction compensation method performed by at least one processor includes acquiring sensor data of a vehicle through OBD associated with the vehicle, calculating carbon emissions according to driving of the vehicle by using the acquired sensor data, determining carbon reductions according to driving of the vehicle based on the calculated carbon emissions, performing trading of CERs according to the determined carbon reductions through a carbon trading market, and providing a portion of an amount obtained through the trading to a first user account associated with the vehicle.

According to an example embodiment, the calculating of the carbon emissions according to driving of the vehicle by using the acquired sensor data may include generating preprocessed data by performing preprocessing on the sensor data, and calculating carbon emissions according to driving of the vehicle by providing the generated preprocessed data to a trained artificial neural network model.

According to an example embodiment, the calculating of the carbon emissions according to driving of the vehicle by providing the generated preprocessed data to the trained artificial neural network model may include performing feature selection on the preprocessed data, and calculating carbon emissions according to driving of the vehicle by providing a feature point of the preprocessed data extracted by the feature selection to the trained artificial neural network model.

According to an example embodiment, the artificial neural network model may be a transformer-based model.

According to an example embodiment, the determining of the carbon reductions according to driving of the vehicle based on the calculated carbon emissions may include acquiring carbon emissions of an internal combustion vehicle of a grade corresponding to the vehicle from a carbon emissions database, and determining the carbon reductions by comparing the carbon emissions according to driving of the vehicle and the carbon emissions of the internal combustion vehicle.

According to an example embodiment, the method may further include storing the determined carbon reductions according to driving of the vehicle in a cloud system-based carbon reductions database.

According to an example embodiment, the method may further include acquiring charging data including a fuel charging amount for the vehicle from a charging device of a vehicle charging station, and when the trading of the CERs according to driving of the vehicle is performed, providing a portion of an amount obtained through the trading to a second user account associated with the charging device.

According to an example embodiment, the performing of the trading of the CERs according to the determined carbon reductions through the carbon trading market may include receiving a trading request for the CERs from a user terminal associated with the vehicle, and performing trading of the CERs according to the determined carbon reductions, when the trading request is received.

According to an example embodiment, the sensor data may include driving information of the vehicle for a predetermined time.

According to an example embodiment, the sensor data may include information on at least one of engine load, engine RPM, driving speed, coolant temperature, mileage, fuel flow, throttle, and acceleration of the vehicle.

A computing device according to an example embodiment includes a communication module, a memory, and at least one processor which is coupled to the memory and configured to execute at least one computer-readable program included in the memory. At least one program includes instructions for acquiring sensor data of a vehicle through OBD associated with the vehicle, calculating carbon emissions according to driving of the vehicle by using the acquired sensor data, determining carbon reductions according to driving of the vehicle based on the calculated carbon emissions, performing trading of CERs according to the determined carbon reductions through a carbon trading market, and providing a portion of an amount obtained through the trading to a first user account associated with the vehicle.

In various example embodiments, drivers of hydrogen vehicles, electric vehicles, and the like may simply earn profits by providing only sensor data collected through the OBD scanner to a computing device, and businesses associated with the computing device may continue to earn profits through CERs trading brokerage.

In various example embodiments, a computing device may sell CERs according to total reliable carbon reductions through a corporate carbon trading market, and may effectively perform individuals’ CERs trading.

In various example embodiments, a transformer-based artificial neural network model including an encoder and a decoder may calculate carbon emissions of a vehicle more precisely by using correlations according to location information of each feature point to calculate carbon emissions.

In various example embodiments, carbon reductions associated with a specific vehicle and/or a user account may be accumulated for a specific period of time, and the user may request or perform a CERs trading for the accumulated carbon reductions.

Effects of example embodiments are not limited to the above-mentioned effects, and other effects not mentioned will be clearly understood by those having ordinary skill in the art (referred to as “those skilled in the art”) from the descriptions of the claims.

### BRIEF DESCRIPTION OF THE DRAWINGS

Example embodiments will be described with reference to the accompanying drawings described below, wherein like reference numerals denote like elements, but are not limited thereto.

FIG. 1 is a block diagram illustrating an example in which a computing device according to an example embodiment exchanges data and/or information required for CERs trading with a vehicle and a carbon trading market.

FIG. 2 is a functional block diagram illustrating an internal configuration of a computing device according to an example embodiment.

FIG. 3 is a diagram illustrating an example of a process in which sensor data is used as an input of an artificial neural network model according to an example embodiment.

FIG. 4 is a diagram illustrating an example of a transformer-based artificial neural network model according to an example embodiment.

FIG. 5 is a block diagram illustrating an example of calculating carbon reductions according to an example embodiment.

FIG. 6 is a block diagram illustrating an example in which a computing device according to an example embodiment exchanges data and/or information required for CERs trading with a vehicle, a charging device, and a carbon trading market.

FIG. 7 is a flowchart illustrating an example of an OBD-based carbon reduction compensation method according to an example embodiment.

FIG. 8 is a flowchart illustrating an example of a CERs trading method according to an example embodiment.

FIG. 9 is a block diagram illustrating an internal configuration of a computing device according to an example embodiment.

### DETAILED DESCRIPTION

Hereinafter, specific contents for carrying out example embodiments will be described in detail with reference to the accompanying drawings. However, in the following description, if there is a risk of unnecessarily obscuring the gist of the present disclosure, detailed descriptions of well-known functions or configurations will be omitted.

In the accompanying drawings, the same or corresponding components are assigned the same reference numerals. In addition, in the description of the example embodiments below, overlapping description of the same or corresponding components may be omitted. However, even if descriptions regarding components are omitted, it is not intended that such components are not included in any embodiment.

Advantages and features of the disclosed embodiments, and methods of achieving them, will become apparent with reference to the example embodiments described below in conjunction with the accompanying drawings. However, the present disclosure is not limited to example embodiments disclosed below, but may be implemented in various different forms, and these example embodiments are provided only so that the present disclosure may be thorough and may fully inform those skilled in the art of the scope of the disclosure.

Terms used herein will be briefly described, and the disclosed embodiments will be described in detail. The terms used herein have been selected as currently widely used general terms as possible while considering the functions in the present disclosure, but may vary depending on the intention or precedent of a person skilled in the art, the emergence of new technology, and the like. In addition, in a specific case, there is a term arbitrarily selected by the applicant, and in this case, the meaning will be described in detail in the corresponding part of the detailed description. Therefore, the terms used herein should be defined based on the meaning of the term and the overall content of the present disclosure, rather than the simple name of the term.

The singular forms herein include plural forms unless the context clearly dictates the singular. Also, the plural forms include the singular forms unless the context clearly dictates the plural. Throughout the specification, when a part includes a certain component, this means that other components may be further included, rather than excluding other components, unless otherwise stated.

As used herein, the terms “comprises” and/or “comprising” specify the presence of features, steps, operations, elements, and/or components, but do not preclude the presence or addition of one or more other features, steps, operations, elements, components, and/or combinations thereof.

As used herein, when a particular component is referred to as “coupled,” “combined,” “connected,” or “reacted” to any other component, the particular component may be directly coupled, combined and/or connected to the other component, or reacted with the other component, but is not limited thereto. For example, there may be one or more intermediate components between a particular component and another component. As used herein, “and/or” may include each of one or more listed items or a combination of at least a portion of one or more items.

As used herein, terms such as “first” and “second” are used to distinguish a specific component from other components, and the above-described components are not limited by these terms. For example, a “first” component may be an component of the same or similar type as a “second” component.

In the present disclosure, “on board diagnostics (OBD)” and/or “OBD scanner” is a diagnostic standard and/or device for checking and controlling the electrical/electronic operating state of a vehicle, which may serve as an interface as a trip computer providing various vehicle information (e.g., sensor data) to the driver. For example, OBD may include OBD-1, OBD-2, and the like, but is not limited thereto.

In the present disclosure, a “computing device” may be any device for performing or brokering CERs trading using data acquired from an OBD scanner of a vehicle and/or a user terminal associated with the vehicle (e.g., an application installed on the user terminal, etc.). According to an example embodiment, the computing device may perform carbon emissions calculation, carbon reductions determination, CERs trading brokerage, and the like.

In the present disclosure, a “user account” is an account on any application that provides a CERs trading brokerage service, and may be an account associated with a user’s financial account or the like.

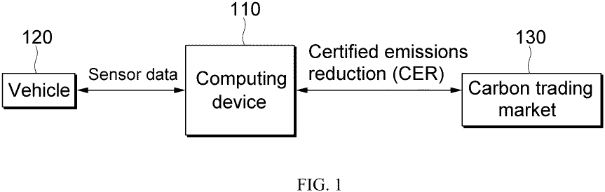

FIG. 1 is a block diagram illustrating an example of a computing device 110 according to an example embodiment exchanging data and/or information required for CERs trading with a vehicle 120 and a carbon trading market 130. According to an example embodiment, the computing device 110 may be any device for calculating carbon emissions and/or carbon reductions of the vehicle 120 by using the sensor data received from the vehicle 120, and performing carbon trading accordingly. In addition, the vehicle 120 may include a terminal and a control device associated with the vehicle 120, and the carbon trading market 130 may include a server, a device, etc. for performing carbon trading.

According to an example embodiment, the vehicle 120 monitors systems related to exhaust gas, boil-off gas, etc. of the vehicle 120 while driving, and may include an OBD system capable of diagnosing whether the monitoring systems fail. In other words, the OBD system is a system capable of collecting, monitoring, managing, and/or processing vehicle information, and may include, for example, an OBD-2 system. When using such an OBD system and/or an OBD scanner, sensor data including vehicle state, fuel efficiency according to driving of the vehicle, acceleration information, and the like may be simply collected.

According to an example embodiment, the computing device 110 may acquire sensor data collected from the vehicle 120 using an OBD scanner. Further, the computing device 110 may calculate carbon emissions according to driving of the vehicle 120 by using the acquired sensor data. For example, carbon emissions of the vehicle 120 may be determined differently depending on the driving speed, rapid acceleration/deceleration, mileage, etc., and the computing device 110 may calculate the carbon emission amount of the vehicle 120 in real time and/or based on a predetermined time period using the acquired sensor data. Here, carbon emissions may be calculated by a predetermined algorithm and/or a trained machine learning model.

According to an example embodiment, the computing device 110 may determine carbon reductions according to driving of the vehicle 120 based on the calculated carbon emissions. For example, the computing device 110 may acquire information on the average and/or specific standard carbon emissions of internal combustion vehicles of various grades from an arbitrary database, and may determine the carbon reductions by comparing carbon emissions of the internal combustion vehicle of a grade corresponding to the vehicle 120 (e.g., the same grade) and the calculated carbon emissions of the vehicle 120. In other words, carbon reductions may be determined by the difference between the carbon emissions of an internal combustion vehicle of the same grade having a specific standard and the carbon emissions of the vehicle 120.

According to an example embodiment, the computing device 110 determines CERs according to carbon reductions of the vehicle 120, and may trade and/or sell the CERs through the carbon trading market. Then, a portion of the sales amount may be provided to a user account associated with the vehicle 120 (e.g., a user account on any application associated with carbon trading of the user terminal). For example, a portion of the amount obtained through the trading of the CERs may be provided to the user, and the other portion of the amount may be provided to any account associated with the computing device 110 as a trade fee.

In FIG. 1, the computing device 110 is illustrated as acquiring sensor data from one vehicle 120, but the present disclosure is not limited thereto, and the computing device 110 communicates with a plurality of vehicles and may acquire sensor data of each of the plurality of vehicles. In this case, the computing device 110 may generate CERs corresponding to carbon reductions of a plurality of vehicles and perform trades of the generated CERs. With such a configuration, drivers of hydrogen vehicles or electric vehicles may simply earn profits by providing only sensor data collected through an OBD scanner (e.g., an OBD-2 scanner, etc.) to the computing device 110, and the businesses associated with the computing device 110 may continuously earn profits through CERs trading brokerage.

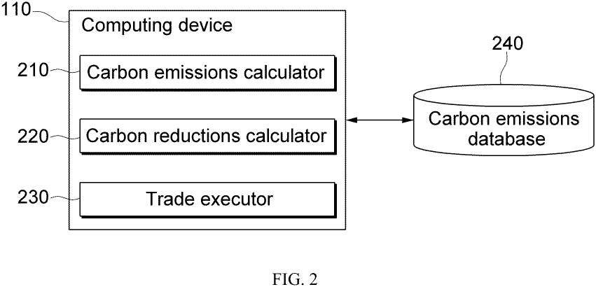

FIG. 2 is a functional block diagram illustrating an internal configuration of the computing device 110 according to an example embodiment. As shown, the computing device 110 may include a carbon emissions calculator 210, a carbon reductions calculator 220, a trade executor 230, and the like, but is not limited thereto. The computing device 110 may communicate with the carbon emissions database 240 and the like, and may exchange data and/or information required for carbon reductions calculation and/or CERs trading. Here, the computing device 110 may be an edge computing-based edge device that processes data from a computing resource located at the edge of the network, but is not limited thereto. For example, the computing device 110 may be a fog node based on fog computing that performs calculations by placing a fog node between the cloud and the end device.

According to an example embodiment, the carbon emissions calculator 210 may acquire sensor data of the vehicle through OBD associated with the vehicle, and calculate carbon emissions according to the vehicle driving by using the acquired sensor data. Here, the sensor data may include driving information of the vehicle for a predetermined time and/or period, and the carbon emissions may be a predicted carbon emissions according to the vehicle driving for a predetermined time and/or period.

According to an example embodiment, the carbon emissions calculator 210 performs preprocessing on the sensor data to generate preprocessing data, and provides the generated preprocessing data to the trained artificial neural network model to calculate carbon emissions according to the vehicle driving. For example, the carbon emissions calculator 210 may transform sensor data, which is raw data, into a data format such as a matrix or vector suitable for use as an input to an artificial neural network model, and generate preprocessed data by generating features and/or feature values. Then, the carbon emissions calculator 210 may calculate the carbon emissions by providing the preprocessed data generated in this way to the artificial neural network model.

The carbon reductions calculator 220 may determine carbon reductions according to the vehicle driving based on the calculated carbon emissions. According to one embodiment, the carbon reductions calculator 220 may determine the grade of the vehicle as light, small, semi-medium, medium, semi-large, large, etc. based on the size of the vehicle, or determine the grade of the vehicle in 5 grades according to the amount of air pollutants emitted by the vehicle. Then, the carbon reductions calculator 220 may extract or acquire carbon emissions having a specific standard (e.g., average) of an internal combustion vehicle of the same grade as the vehicle. For example, the carbon reductions calculator 220 may extract or acquire carbon emissions of the internal combustion vehicle of the grade corresponding to the vehicle from the carbon emissions database 240 in which the carbon emissions of the internal combustion vehicle according to the vehicle grade is stored. In this case, the carbon reductions calculator 220 may determine carbon reductions by comparing the carbon emissions according to the vehicle driving and the carbon emissions of the internal combustion vehicle.

The trade executor 230 may generate CERs according to the determined carbon reductions of the vehicle and perform a trade on the CERs generated through the carbon trading market. Then, the trade executor 230 may provide a portion of the amount obtained through the trade to the user account associated with the vehicle. According to an example embodiment, the trade executor 230 may generate CERs of a plurality of vehicles using the CERs brokerage service provided by the computing device 110, and collect and process the generated CERs to sell through the carbon trading market. In this case, when receiving a trade request for CERs from a user terminal associated with the vehicle, the trade executor 230 may perform a trade for the CERs. In other words, the trade executor 230 may collect and process the CERs of the vehicle to which the trade request is transmitted, and sell it through the carbon trading market.

In FIG. 2, each functional configuration included in the computing device 110 has been described separately, but this is only to help the understanding of the present disclosure, and one computing device may perform two or more functions. With this configuration, the computing device 110 may sell CERs according to the total reliable carbon reductions through the corporate carbon trading market, and may effectively perform individuals’ CERs trading.

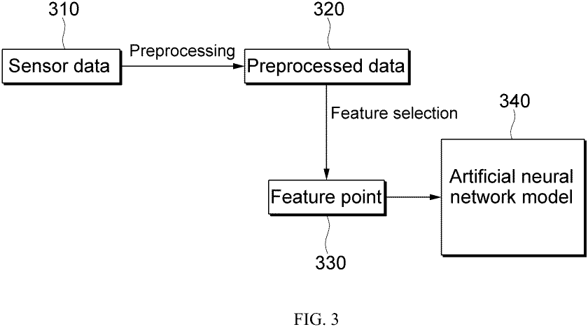

FIG. 3 is a diagram illustrating an example of a process in which sensor data 310 is used as an input of an artificial neural network model 340 according to an example embodiment. As described above, the sensor data 310 may be data acquired through an OBD scanner connected to the OBD system of the vehicle, and may include driving information of the vehicle for a predetermined time. The computing device (110 of FIG. 1) may acquire the sensor data 310, and perform preprocessing on the sensor data 310 to generate preprocessed data 320. For example, the sensor data 310 and/or the preprocessed data 320 may include features as shown in Table 1 below.

TABLE 1

| feature | units | range | ID |
|---|---|---|---|
| Engine Load | % | 0 - 100 | 1 |
| Speed | km/h | 0 - 121 | 2 |
| Coolant Temperature | °C | 60 - 100 | 3 |
| Engine RPM | Revolutions/min | 0 - 5500 | 4 |
| Mileage | km/1 | 0 - 45 | 5 |
| Fuel Flow | cc/min | 0 - 350 | 6 |
| Throttle | % | 0 - 100 | 7 |
| Acceleration | km/s² | -25 - 45 | 8 |

In other words, the sensor data 310 may include wherein the sensor data includes information on at least one of engine load, engine revolution per minute (RPM), driving speed, coolant temperature, mileage, fuel flow, throttle and acceleration of the vehicle, and the pre-processed data 320 may be generated by performing preprocessing on such information.

According to an example embodiment, feature selection may be performed on the preprocessed data 320 to extract or generate a feature point 330. For example, among the features included in the preprocessed data 320, at least some features affecting the determination of carbon emissions may be extracted through feature selection. In this case, any algorithm and/or machine learning model for feature selection may be used.

The selected feature point 330 may be used as an input of the artificial neural network model 340. In other words, the artificial neural network model 340 may output carbon emissions of the vehicle using the feature point 330. Here, the artificial neural network model 340 may include a long short term memory (LSTM)-based model, a transformer-based model, and the like, but is not limited thereto. According to an example embodiment, data cleaning may be performed on the preprocessed data 320 and/or the feature point 330. For example, interpolation, filtering, missing value removal and/or replacement, normalization, or the like may be performed on a value associated with the feature point 330. As the data refinement is performed in this way, the prediction accuracy of the artificial neural network model 340 may be increased.

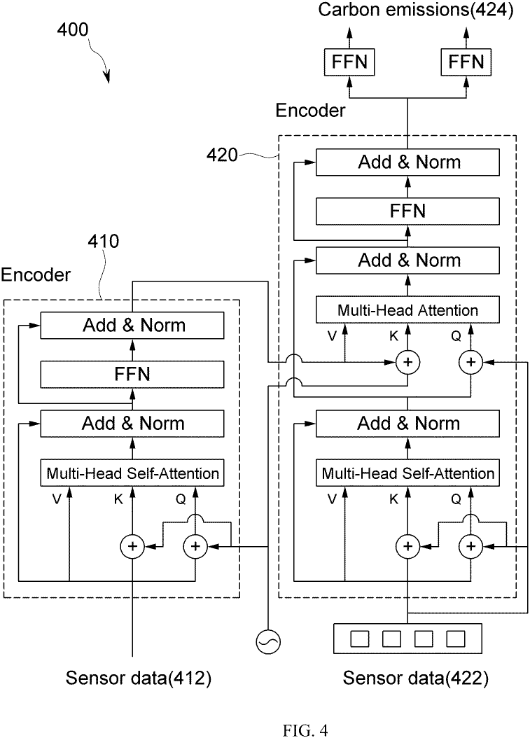

FIG. 4 is a diagram illustrating an example of a transformer-based artificial neural network model 400 according to an example embodiment. According to an example embodiment, the transformer-based artificial neural network model 400 may be a model for performing analysis of time series data having continuity using an attention layer. As shown, the transformer-based neural network model 400 may include an encoder 410 and a decoder 420, but is not limited thereto, and the artificial neural network model 400 may be configured to include a plurality of encoders and a plurality of decoders.

The transformer-based artificial neural network model 400 may receive sensor data 412 as an input sequence through the encoder 410, and may output carbon emissions 424 as an output sequence through the decoder 420. According to an example embodiment, the encoder 410 and/or the decoder 420 may include a multi-head self-attention layer that uses self-attention in parallel and a feed-forward neural network.

According to an example embodiment, the transformer-based artificial neural network model 400 may perform positional encoding on the feature points associated with the sensor data 412, and may add position information to the embedding vector of each feature point and provide it to the encoder 410. The encoder 400 may perform an operation on such an embedding vector, and the output of the encoder 410 may be used in the attention layer of the decoder 420. In this case, the decoder 420 may output carbon emissions 424 using the output of the encoder 410 and the sensor data 422 after the time period t. With such a configuration, the transformer-based artificial neural network model 400 including the encoder 410 and the decoder 420 may calculate carbon emissions 424 more precisely using the correlation according to the location information of each feature point to calculate carbon emissions.

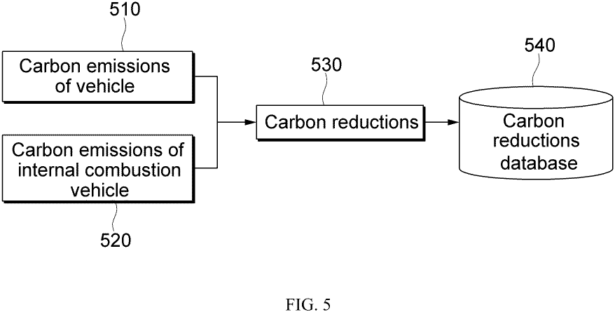

FIG. 5 is a block diagram illustrating an example of calculating carbon reductions 530 according to an example embodiment. As described above, the computing device (110 of FIG. 1) may acquire sensor data of the vehicle through OBD associated with the vehicle, and calculate carbon emissions 510 according to the vehicle driving by using the acquired sensor data. Further, the computing device may determine carbon reductions 530 according to the vehicle driving based on the calculated carbon emissions 510.

According to an example embodiment, the computing device may acquire carbon emissions 520 of the internal combustion vehicle of a grade corresponding to the vehicle from the carbon emissions database (not shown), and determine carbon reductions 530 by comparing carbon emissions according to the vehicle driving 510 and carbon emissions of the internal combustion vehicle 520. For example, the carbon emissions database may include information on the average carbon emissions of internal combustion vehicles of each grade, and the computing device may determine the vehicle grade and acquire carbon emissions of the internal combustion vehicle 520 corresponding to the determined grade. Then, carbon reductions 530 may be determined based on the difference between carbon emissions of the internal combustion vehicle 520 and carbon emissions according to the vehicle driving 510.

According to an example embodiment, the calculated carbon reductions 530 of the vehicle may be stored and managed in the carbon reductions database 540. Here, the carbon reductions database 540 may be a cloud system-based storage device. For example, carbon reductions 530 may be stored separately for each vehicle and/or user account associated with the vehicle. As such, carbon reductions associated with a specific vehicle and/or user account may be accumulated for a specific period, and the user may request or perform a CERs trade for accumulated carbon reductions.

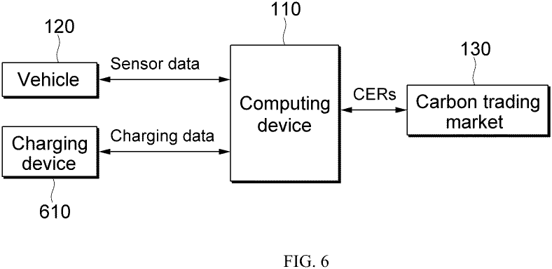

FIG. 6 is a block diagram illustrating an example in which the computing device 110 according to an example embodiment exchanges data and/or information required for CERs trading with a vehicle 120, a charging device 610, and a carbon trading market 130. As described above, the computing device 110 may acquire sensor data collected from the vehicle 120 using the OBD scanner. Also, the computing device 110 may calculate carbon emissions according to the vehicle 120 driving by using the acquired sensor data. In this case, the computing device 110 may determine carbon reductions according to the vehicle 120 driving based on the calculated carbon emissions.

According to an example embodiment, the computing device 110 may acquire charging data including a fuel charging amount for the vehicle 120 from the charging device 610 of the charging station. Here, the charging station may include an electric charging station, a hydrogen charging station, and the like, and the charging data may include information on fuel charging amount, charging time, charger pressure, and the like of electricity, hydrogen, etc. Then, the computing device 110 may calculate carbon reductions by charging based on the charging data or determine the contribution of the charging device 610 to carbon reductions of the vehicle 120. In this case, any algorithm and/or machine learning model for determining carbon reductions and/or contribution may be used.

According to an example embodiment, the computing device 110 may perform a trade for CERs and provide a portion of the amount obtained through the trade to the first user account associated with the vehicle 120. In this case, the computing device 110 may provide another portion of the amount obtained through the trade to the second user account associated with the charging device 610. In other words, the profits from CERs trading may be distributed to the account associated with the computing device 110 that provides the brokerage service, the first user account associated with the vehicle 120, the second user account associated with the charging device 610, etc. With such a configuration, the driver of the vehicle 120 and the operator of the charging station may receive a share in profits according to CERs trading simply by providing sensor data and/or charging data.

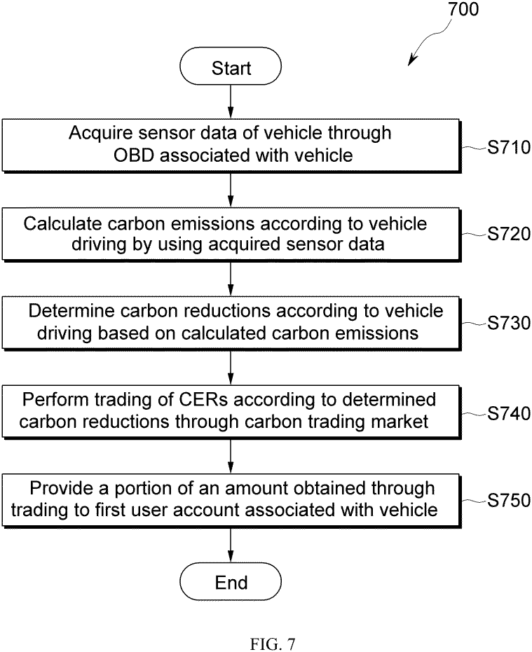

FIG. 7 is a flowchart illustrating an example of an OBD-based carbon reduction compensation method 700 according to an example embodiment. The OBD-based carbon reduction compensation method 700 may be performed by at least one processor (e.g., at least one processor of a computing device). The OBD-based carbon reduction compensation method 700 may be initiated when the processor acquires sensor data of the vehicle through OBD associated with the vehicle (S710).

The processor may calculate carbon emissions according to the vehicle driving by using the acquired sensor data (S720). For example, the processor may perform preprocessing on the sensor data to generate preprocessed data, and provide the generated preprocessied data to the trained artificial neural network model to calculate carbon emissions according to the vehicle driving. In this case, the processor may perform feature selection on the preprocessed data, and provide the feature points of the preprocessed data extracted by the feature selection to the trained artificial neural network model to calculate carbon emissions according to the vehicle driving. Here, the artificial neural network model may be a transformer-based model.

The processor may determine carbon reductions according to the vehicle driving based on the calculated carbon emissions (S730). For example, the processor may acquire carbon emissions of an internal combustion vehicle of a grade corresponding to the vehicle from the carbon emission database, and determine carbon reductions by comparing the carbon emissions according to the vehicle driving and the carbon emissions of the internal combustion vehicle.

Then, the processor may perform trading of CERs according to the determined carbon reductions through the carbon trading market (S740). In this case, the processor may provide a portion of the amount obtained through the trading to the first user account associated with the vehicle. Additionally, the processor may acquire charging data including the amount of fuel charged for the vehicle from the charging device of the vehicle charging station, and provide a portion of the amount obtained through the trading to the second user account associated with the charging device when the trading of CERs according to the vehicle driving is performed.

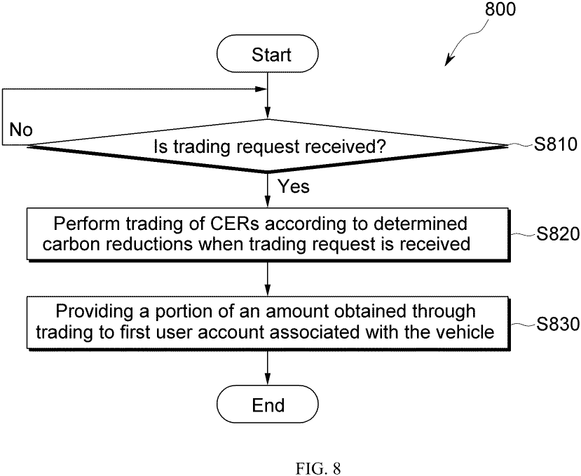

FIG. 8 is a flowchart illustrating an example of a CERs trading method 800 according to an example embodiment. The CERs trading method 800 may be performed by at least one processor (e.g., at least one processor of a computing device). The CERs trading method 800 may be initiated by determining whether the processor receives a trading request for CERs from a user terminal associated with the vehicle (S810).

Carbon reductions of vehicles and/or user accounts may be accumulated on a carbon reductions database. When the carbon reductions of the accumulated user account is equal to or greater than a predetermined criterion, the processor may receive a trading request for CERs from the user terminal associated with the vehicle. When the trading request is received in this way, the processor may perform trading of CERs according to the determined carbon reductions (S820). Also, the processor may provide a portion of the amount obtained through the trading to the first user account associated with the vehicle (S830).

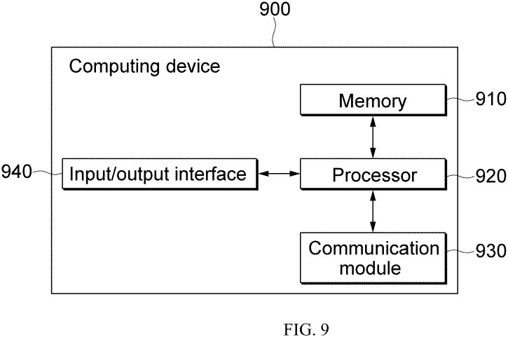

FIG. 9 is a block diagram illustrating an internal configuration of a computing device 900 according to an example embodiment. The computing device 900 may include a memory 910, a processor 920, a communication module 930, and an input/output interface 940. Here, the computing device 900 may include any system and/or device (e.g., 110 in FIG. 1) that brokers CERs trading. As illustrated in FIG. 9, the computing device 900 may be configured to communicate information and/or data through a network using the communication module 930.

The memory 910 may include any non-transitory computer-readable recording medium. According to an example embodiment, the memory 910 may include a permanent mass storage device such as a random access memory (RAM), read only memory (ROM), disk drive, solid state drive (SSD), flash memory, etc. As another example, a permanent mass storage device such as a ROM, an SSD, a flash memory, a disk drive, etc. may be included in the computing device 900 as a separate persistent storage device distinct from the memory. Further, an operating system and at least one program code may be stored in the memory 910.

These software components may be loaded from a computer-readable recording medium separate from the memory 910. Such a separate computer-readable recording medium may include a recording medium directly connectable to the computing device 900, for example, it may include a computer-readable recording medium such as a floppy drive, a disk, a tape, a DVD/CD-ROM drive, a memory card, etc. As another example, software components may be loaded into the memory 910 through the communication module 930 instead of a computer-readable recording medium. For example, at least one program may be loaded into the memory 910 based on a computer program installed by the files provided through the communication module 930 by developers or a file distribution system that distributes installation files of applications.

The processor 920 may be configured to process instructions of a computer program by performing basic arithmetic, logic, and input/output operations. The instruction may be provided to a user terminal (not shown) or another external system by the memory 910 or the communication module 930.

The communication module 930 may provide a configuration or function for the user terminal (not shown) and the computing device 900 to communicate with each other through a network, and provide a configuration or function for the the computing device 900 to communicate with an external system (e.g., a separate cloud system, etc.). For example, control signals, instructoins, data, etc. provided under the control of the processor 920 of the computing device 900 may be transmitted to the user terminal and/or the external system through the communication module 930 and the network via the user terminal and/or the communication module of the external system.

Further, the input/output interface 940 of the computing device 900 may be a means for interfacing with a device (not shown) for input or output that may be connected with the computing device 900 or that the computing device 900 may include. Although the input/output interface 940 is illustrated as a component configured separately from the processor 920 in FIG. 9, the present disclosure is not limited thereto, and the input/output interface 940 may be configured to be included in the processor 920. The computing device 900 may include more components than those of FIG. 9. However, there is no need to clearly show most of the prior art components.

The processor 920 of the computing device 900 may be configured to manage, process, and/or store information and/or data received from a plurality of user terminals and/or a plurality of external systems.

The above-described method and/or various embodiments may be implemented in digital electronic circuitry, computer hardware, firmware, software, and/or combinations thereof. Various example embodiments may be executed by a data processing device, for example, one or more programmable processors and/or one or more computing devices, or may be implemented as a computer program stored in a computer-readable recording medium and/or computer-readable recording medium. The above-described computer program may be written in any form of programming language including a compiled language or an interpreted language, and may be distributed in any form such as a stand-alone program, a module, a subroutine, or the like. The computer program may be distributed through one computing device, a plurality of computing devices connected through the same network, and/or a plurality of distributed computing devices connected through a plurality of different networks.

The methods and/or various embodiments described above may performed by one or more processors configured to execute one or more computer programs that process, store, and/or manage any functions, etc., by operating on the basis of input data or generating output data. For example, the method and/or various example embodiments may be performed by a special purpose logic circuit such as a Field Programmable Gate Array (FPGA) or Application Specific Integrated Circuit (ASIC), and the device and/or systems for carrying out the method and/or various example embodiments may be implemented as special purpose logic circuits such as FPGAs or ASICs.

The one or more processors executing the computer program may include general purpose or special purpose microprocessors and/or one or more processors of any kind of digital computing device. The processor may receive instructions and/or data from each of the read-only memory and the random access memory, or may receive instructions and/or data from the read-only memory and the random access memory. In the present disclosure, the components of a computing device performing the method and/or embodiments may include one or more processors for executing instructions, one or more memory devices for storing instructions and/or data.

According to an example embodiment, the computing device may send and receive data to and from one or more mass storage devices for storing data. For example, the computing device may receive data from, and/or transmit data to, a magnetic or optical disc. A computer-readable storage medium suitable for storing instructions and/or data associated with a computer program includes a semiconductor memory device such as an Erasable Programmable Read-Only Memory (EPROM), an Electrically Erasable PROM (EEPROM), or a flash memory device. It may include any type of non-volatile memory, but is not limited thereto. For example, computer-readable storage media may include magnetic disks such as internal hard disks or removable disks, magneto-optical disks, CD-ROM and DVD-ROM disks.

To provide for interaction with the user, the computing device may include, but is not limited to, a display device (e.g., a cathode ray tube (CRT), liquid crystal display (LCD), etc.) for presenting or displaying information to the user, and a pointing device (e.g., a keyboard, a mouse, a trackball, etc.) through which a user may provide input and/or instructions, etc. on the computing device. In other words, the computing device may further include any other kind of devices for providing interaction with a user. For example, the computing device may provide any form of sensory feedback to the user for interaction with the user, including visual feedback, auditory feedback, and/or tactile feedback, and the like. In contrast, the user may provide an input to the computing device through various gestures such as sight, voice, and motion.

In the present disclosure, various embodiments may be implemented in a computing system including a back-end component (e.g., a data server), a middleware component (e.g., an application server) and/or a front-end component. In this case, the components may be interconnected by any form or medium of digital data communication, such as a communication network. For example, the communication network may include a local area network (LAN), a wide area network (WAN), and the like.

A computing device based on the exemplary embodiments described herein may be implemented using hardware and/or software configured to interact with a user, including a user device, a user interface (UI) device, a user terminal, or a client device. For example, the computing device may include a portable computing device such as a laptop computer. Additionally or alternatively, the computing device may include Personal Digital Assistants (PDA), tablet PCs, game consoles, wearable devices, internet of things (IoT) devices, virtual reality (VR) devices, AR (augmented reality) device, but is not limited thereto. The computing device may further include other types of devices configured to interact with the user. In addition, the computing device may include a portable communication device (e.g., a mobile phone, a smart phone, a wireless cellular phone, etc.) suitable for wireless communication over a network, such as a mobile communication network, and the like. A computing device may be configured to communicate wirelessly with a network server using wireless communication technologies and/or protocols such as Radio Frequency (RF), Microwave Frequency (MWF), and/or Infrared Ray Frequency (IRF).

Various example embodiments, including specific structural and functional details, are exemplary. Accordingly, example embodiments are not limited to those described above, and may be implemented in various other forms. In addition, the terminology used in the present disclosure is for describing some embodiments and is not to be construed as limiting the example embodiments. For example, singular words and the above may be construed to include the plural as well, unless the context clearly dictates otherwise.

In the present disclosure, unless otherwise defined, all terms used herein, including technical or scientific terms, have the same meaning as commonly understood by one of ordinary skill in the art to which the concept belongs. In addition, commonly used terms such as terms defined in the dictionary should be interpreted as having a meaning consistent with the meaning in the context of the related art.

Although the present disclosure has been described with reference to some example embodiments, various modifications and changes can be made without departing from the scope of the present disclosure that can be understood by those skilled in the art to which the present disclosure pertains. Further, such modifications and variations are intended to fall within the scope of the claims appended hereto.

What is claimed is:

1. An on board diagnostics (OBD)-based carbon reduction compensation method performed by at least one processor, comprising:
acquiring sensor data of a vehicle through OBD associated with the vehicle;
calculating carbon emissions according to driving of the vehicle by using the acquired sensor data;
determining carbon reductions according to driving of the vehicle based on the calculated carbon emissions;
performing trading of certified emissions reductions (CERs) according to the determined carbon reductions through a carbon trading market; and
providing a portion of an amount obtained through the trading to a first user account associated with the vehicle.

2. The OBD-based carbon reduction compensation method of claim 1, wherein the calculating of the carbon emissions according to driving of the vehicle by using the acquired sensor data comprises:
generating preprocessed data by performing preprocessing on the sensor data; and
calculating carbon emissions according to driving of the vehicle by providing the generated preprocessed data to a trained artificial neural network model.

3. The OBD-based carbon reduction compensation method of claim 2, wherein the calculating of the carbon emissions according to driving of the vehicle by providing the generated preprocessed data to the trained artificial neural network model comprises:
performing feature selection on the preprocessed data; and
calculating carbon emissions according to driving of the vehicle by providing a feature point of the preprocessed data extracted by the feature selection to the trained artificial neural network model.

4. The OBD-based carbon reduction compensation method of claim 2, wherein the artificial neural network model is a transformer-based model.

5. The OBD-based carbon reduction compensation method of claim 1, wherein the determining of the carbon reductions according to driving of the vehicle based on the calculated carbon emissions comprises:
acquiring carbon emissions of an internal combustion vehicle of a grade corresponding to the vehicle from a carbon emissions database; and
determining the carbon reductions by comparing the carbon emissions according to driving of the vehicle and the carbon emissions of the internal combustion vehicle.

6. The OBD-based carbon reduction compensation method of claim 1, further comprising storing the determined carbon reductions according to driving of the vehicle in a cloud system-based carbon reductions database.

7. The OBD-based carbon reduction compensation method of claim 1, further comprising:
acquiring charging data including a fuel charging amount for the vehicle from a charging device of a vehicle charging station; and
when the trading of the CERs according to driving of the vehicle is performed, providing a portion of an amount obtained through the trading to a second user account associated with the charging device.

8. The OBD-based carbon reduction compensation method of claim 1, wherein the performing of the trading of the CERs according to the determined carbon reductions through the carbon trading market comprises:
receiving a trading request for the CERs from a user terminal associated with the vehicle; and
performing trading of the CERs according to the determined carbon reductions, when the trading request is received.

9. The OBD-based carbon reduction compensation method of claim 1, wherein the sensor data comprises driving information of the vehicle for a predetermined time.

10. The OBD-based carbon reduction compensation method of claim 1, wherein the sensor data comprises information on at least one of engine load, engine revolution per minute (RPM), driving speed, coolant temperature, mileage, fuel flow, throttle, and acceleration of the vehicle.

11. A computing device comprising:
a communication module;
a memory; and
at least one processor which is coupled to the memory and configured to execute at least one computer-readable program included in the memory,
wherein the at least one program comprises instructions for:
acquiring sensor data of a vehicle through on board diagnostics (OBD) associated with the vehicle;
calculating carbon emissions according to driving of the vehicle by using the acquired sensor data;
determining carbon reductions according to driving of the vehicle based on the calculated carbon emissions;
performing trading of certified emission reductions (CERs) according to the determined carbon reductions through a carbon trading market; and
providing a portion of an amount obtained through the trading to a first user account associated with the vehicle.

12. The computing device of claim 11, wherein the at least one program further comprises instructions for:
generating preprocessed data by performing preprocessing on the sensor data; and
calculating the carbon emissions according to driving of the vehicle by providing the generated preprocessed data to a trained artificial neural network model.

13. The computing device of claim 12, wherein the at least one program further comprises instructions for:
performing feature selection on the preprocessed data; and
calculating the carbon emissions according to driving of the vehicle by providing a feature point of the preprocessed data extracted by the feature selection to the trained artificial neural network model.

14. The computing device of claim 12, wherein the artificial neural network model is a transformer-based model.

15. The computing device of claim 11, wherein the at least one program further comprises instructions for:
acquiring carbon emissions of an internal combustion vehicle of a grade corresponding to the vehicle from a carbon emissions database; and
determining the carbon reductions by comparing the carbon emissions according to driving of the vehicle and the carbon emissions of the internal combustion vehicle.

16. The computing device of claim 11, wherein the at least one program further comprises instructions for storing the determined carbon reductions according to driving of the vehicle in a cloud system-based carbon reductions database.

17. The computing device of claim 11, wherein the at least one program further comprises instructions for:
acquiring charging data including a fuel charging amount for the vehicle from a charging device of a vehicle charging station; and
when the trading of the CERs according to driving of the vehicle is performed, providing a portion of an amount obtained through the trading to a second user account associated with the charging device.

18. The computing device of claim 11, wherein the at least one program further comprises instructions for:
receiving a trading request for the CERs from a user terminal associated with the vehicle; and
performing the trading of the CERs according to the determined carbon reductions, when the trading request is received.

19. The computing device of claim 11, wherein the sensor data comprises driving information of the vehicle for a predetermined time.

20. The computing device of claim 11, wherein the sensor data comprises information on at least one of engine load, engine revolution per minute (RPM), driving speed, coolant temperature, mileage, fuel flow, throttle, and acceleration of the vehicle.
